(19) United States
(12) Patent Application Publication
(10) Pub. No.: US 2007/0050984 A1
(43) Pub. Date: Mar. 8, 2007

(54) Portable, hand-held, motor-driven tube cutter

(76) Inventor: Dominick J. Bartoluzzi, Bowie, MD (US)

Correspondence Address: BROOKS KUSHMAN P.C., 1000 TOWN CENTER, TWENTY-SECOND FLOOR, SOUTHFIELD, MI, 48075, US

(21) Appl. No.: 10/554,842

(22) PCT Filed: May 24, 2004
(86) PCT No.: PCT/US04/16274

§ 371 Date: Oct. 20, 2006

Related U.S. Application Data
(60) Provisional application No. 60/475,329, filed on Jun. 4, 2003.

(51) Int. Cl. B23D 21/06

(52) U.S. Cl. 30/93

(57) ABSTRACT

A portable, hand-held, motor-driven tube cutter (126) includes a disc-shaped gear (12A) driven by motor (16). A housing (10) has a roller support (6) and a blade support (12) movably mounted with respect to each other within the housing (10). Roller support (6) and blade support (12) engage grooves (30, 31) in a side of gear (12A). Brake elements (9, 11) are positioned in contacting relationship with housing (10), and supports (6, 12) move toward each from a starting position to cut a tube positioned within the cutter (126) as the motor (16) drives gear (12A) in a forward direction and as the brake elements (9, 11) restrict rotation of the housing (10). Supports (6, 12) move away from each other as the motor (16) drives gear (12A) in a reverse direction and as brake elements (9, 11) restrict rotation of housing (10) so that the tube cutter (126) is returned to its starting position and is ready for the next tube cutting.

### TECHNICAL FIELD

This invention relates to motor-driven tools and more particularly to a portable, hand-held, motor-driven tool for cutting metal and plastic tubing.

### BACKGROUND ART

Cutting of tubing, such as pipes for water and steam, is a common task in construction and remodeling. In the past, tubing cutting has often been done by a worker using a conventional hand-manipulated tubing cutter which makes cuts by the same repeated rotations of the cutter around the tubing. Use of such a conventional hand-manipulated tubing cutter is often fatiguing for the worker and is a time-consuming process. Various types of portable motorized tube cutters are known, but they are complex in design.

### DISCLOSURE OF INVENTION

It is, therefore, an object of the present invention to provide a portable, hand-held, motor-driven tube cutter for cutting plastic or metal tubing, such as water, steam, gas or air pipes, or the like.

Another object is to provide such a tube cutter which automatically adjusts to a range of different size tubing.

A further object of the invention is the provision of such a tube cutter which has no preset blade pressure when cutting the tubing.

Another object of the invention is a tube cutter that is relatively simple in its construction and which is light in weight and easy to manipulate.

Still another object is to provide such a tube cutter which is designed for quick and easy assembly.

Yet another object of the present invention is the provision of such a tube cutter which makes the cutting of tubing easier, faster and safer for the professional and do-it-yourself individual.

A still further object is the provision of such a tube cutter which can be quickly and easily positioned for cutting a continuous tube.

Another object is to provide such a tube cutter which can be used to cut tubes cleanly and quickly without requiring that the tubes be held in a vice or other clamping tool.

Still another object is to provide such a tube cutter in which the motor is reversible so that once the cut is made the motor is reversed (preferably automatically) to return the tube cutter to its initial position to receive a subsequent length of tubing for the next cut.

Yet another object of the present invention is the provision of such a tube cutter which is portable and easily maneuverable for cutting tubing which is already installed and where the ends of the tubing are remote from the location where the tubing is to be cut.

Additional objects and advantages of the invention will be set forth in part in the description which follows, and in part will be obvious from the description, or may be learned by practice of the invention. The objects and advantages are realized and attained by means of the instrumentalities and combinations particularly pointed out in the appended claims.

### BRIEF SUMMARY OF THE INVENTION

To achieve these and other objects, the present invention provides a portable, hand-held, motor-driven tube cutter 126 which includes a disc-shaped gear 12A driven by motor 16. A housing 10 has a roller support 6 and a blade support 12 movably mounted with respect to each other within housing 10. Roller support 6 and blade support 12 engage grooves 30, 31 in a side of gear 12A. Brake elements 9, 11 or other means (182, 184, 186, 188, 190, 192) are positioned in contacting relationship with housing 10, and supports 6, 12 move toward each other to cut a tube positioned within the cutter 126 as the motor 16 drives gear 12A in a forward direction and as the brake elements 9, 11 or other means (182, 184, 186, 188, 190, 192) restrict rotation of housing 10.

It is to be understood that both the foregoing general description and the following detailed description are exemplary and explanatory but are not restrictive of the invention.

### BRIEF DESCRIPTION OF DRAWINGS

The accompanying drawings, which are incorporated in and constitute a part of this specification, illustrate preferred embodiments of the invention and, together with the description, serve to explain the principles of the invention.

FIG. 1 is a perspective view of one preferred embodiment of tube cutter 126;

FIG. 2 is a perspective view of gear 12A;

FIG. 3 is another perspective view of gear 12A;

FIG. 4 is a diagrammatic, perspective view showing internal elements of tube cutter 126;

FIG. 5 is a perspective view of housing 10;

FIG. 6 is another perspective view of housing 10;

FIG. 7 is a perspective view showing roller support 6 and blade support 12;

FIG. 8 is a front elevation view, partly in section, of roller support 6;

FIG. 9 is a front elevation view, partly in section, of blade support 12;

FIG. 10 is a perspective view showing brake elements 9, 11;

FIG. 11 is a diagrammatic, perspective view showing internal elements of tube cutter 126;

FIG. 12 is a diagrammatic, elevation view showing internal elements of tube cutter 126;

FIG. 13 is a diagrammatic, elevation view, partly in section, showing holding means 32, 33;

FIG. 14 is a diagrammatic, elevation view, partly in section, showing internal elements of tube cutter 126;

FIG. 15 is a diagrammatic, elevation view of one embodiment of gear 12A;

FIG. 16 is a diagrammatic, elevation view of another embodiment of gear 12A;

FIG. 17 is an elevation view of still another embodiment of gear 12A;

FIG. 18 is a diagrammatic, elevation view showing an embodiment of gear 12A;

FIG. 19 is a diagrammatic, elevation view showing another embodiment of gear 12A;

FIG. 20 is a diagrammatic, elevation view showing the interrelationship between housing 10 and supports 6 and 12;

FIG. 21 is a diagrammatic, elevation view, partly in section, showing holding means 32′, 33′;

FIG. 22 is a diagrammatic, elevation view of another embodiment of gear 12A;

FIG. 23 is a fragmentary, elevation view, partly in section, showing internal elements of tube cutter 126;

FIG. 24 is a diagrammatic, elevation view showing internal elements of tube cutter 126;

FIG. 25 is a diagrammatic, elevation view showing internal elements of tube cutter 126;

FIG. 26 is a diagrammatic, elevation view showing internal elements of tube cutter 126;

FIG. 27 is a diagrammatic, elevation view showing internal elements of tube cutter 126;

FIG. 28 is a diagrammatic, elevation view showing internal elements of tube cutter 126 as a tube or pipe 176 is cut;

FIG. 29 is a diagrammatic, elevation view showing internal elements of tube cutter 126;

FIG. 30 is a fragmentary, elevation view, partly in section, showing a portion of tube cutter 126;

FIG. 31 is a diagrammatic, elevation view showing supports 6, 12 and tube 176;

FIG. 32 is a diagrammatic, elevation view showing supports 6, 12 and tube 176;

FIG. 33 is a diagrammatic, elevation view showing an alternative configuration for applying force to brake elements 9, 11 and to housing 10;

FIG. 34 is an end elevation view of ring 194, shown in FIG. 33;

FIG. 35 is a diagrammatic, elevation view showing an alternative configuration for retarding rotation of housing 10;

FIG. 36 is an elevation view of hub plate 182, shown in FIG. 35;

FIG. 37 is an elevation view of housing plate 184, shown in FIG. 35;

FIG. 38 is a front elevation view of ring 186, shown in FIG. 35; and

FIG. 39 is an end elevation view of ring 186.

### BEST MODES FOR CARRYING OUT THE INVENTION AND INDUSTRIAL APPLICABILITY

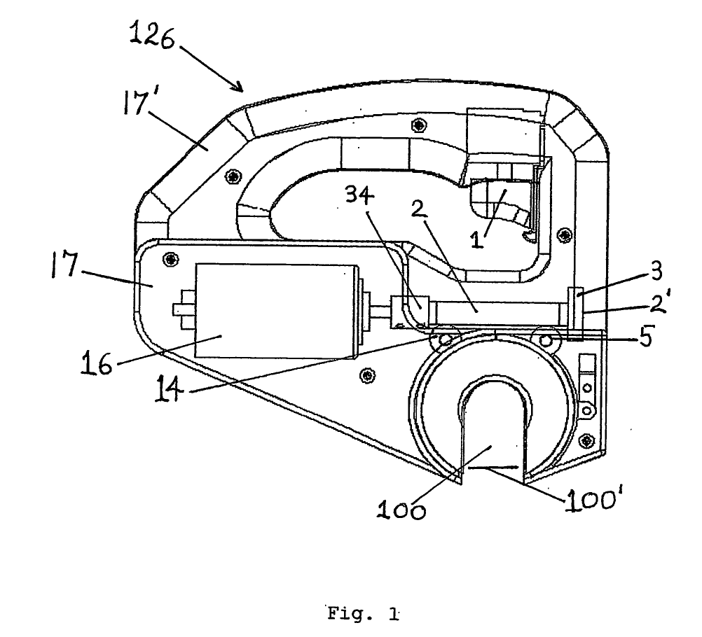

With reference now to the drawings, wherein like reference characters designate like or corresponding parts throughout the several views, there is shown a portable, hand-held, motor-driven tube cutter 126 which includes an exterior case 17 having a handle 17′ and defining a first substantially C-shaped opening 100 therein. Tube cutter 126 is shown in FIG. 1 having a transparent case 17, but it should be understood that case 17 could also be made opaque. Case 17 provides the shape of tube cutter 126 and is used as the mounting structure for the interior parts. The shape of case 17 can be different than that shown in FIG. 1 and is determined by the arrangement of the interior parts.

An electric motor 16 is mounted within case 17 and is connected to a conventional outlet or battery pack (not shown). The speed of motor 16 may or may not be variable. Means 1 are provided in operative relationship with motor 16 and are mounted on case 17 for selectively activating motor 16 in forward and reverse directions. Activating means 1 is preferably a conventional trigger-shaped assembly which controls the on and off function of tube cutter 126. Activating means 1 preferably has a forward and reverse function as well as a variable speed function for controlling the speed of motor 16.

A first gear 2 is conventionally connected to motor 16 by coupler 34, and a bearing 3 is mounted within case 17 for rotatably supporting an end 2′ of first gear 2.

Second 5 and third 14 gears of substantially identical dimensions with respect to each other are rotatably mounted within case 17 by gear shafts 4, 15, respectively. Gears 5, 14 are spaced apart from each other by a predetermined distance and are positioned in engaging relationship with respect to first gear 2.

First C-shaped opening 100 defines a width 100′ of a first predetermined distance, and gears 5, 14 are spaced apart from each other by a second predetermined distance greater than the first predetermined distance (100′). As will be further explained, this spacing apart of gears 5, 14 allows those gears to bridge opening 100 and similar openings in additional parts of the tool, which will be described below.

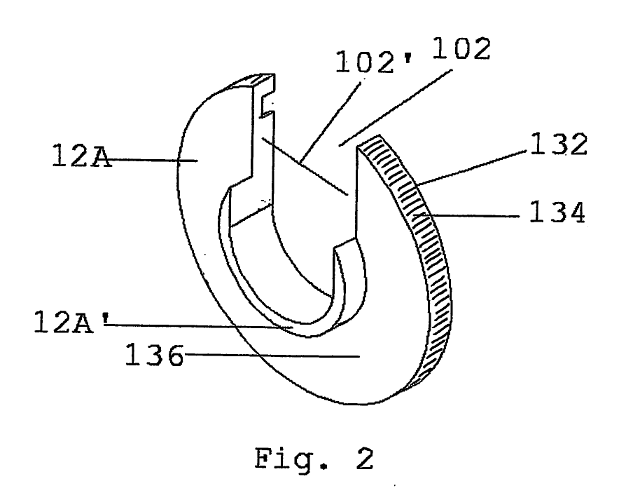

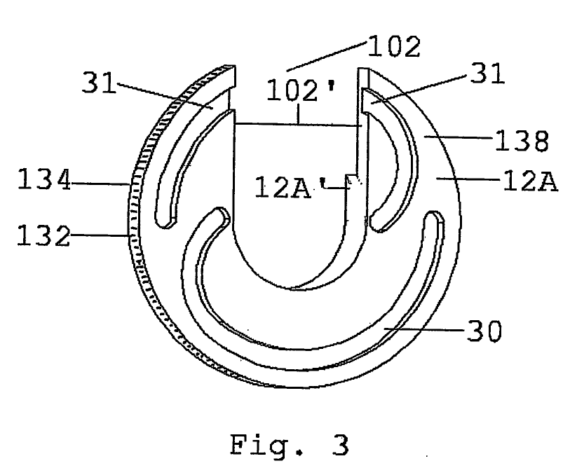

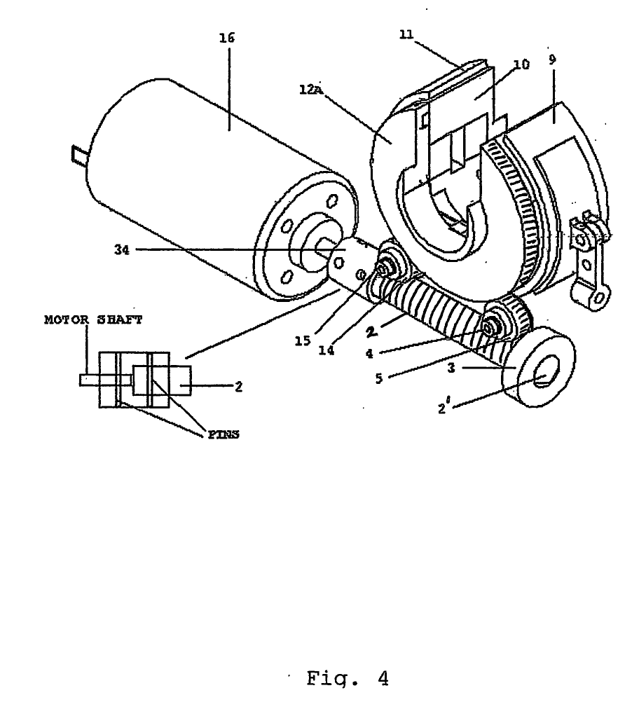

A fourth gear 12A (FIGS. 2 and 3) is rotatably mounted within case 17 and engages second 5 and third 14 gears (FIG. 4). Fourth gear 12A defines a second substantially C-shaped opening 102 having a width 102′ and opening 102 is substantially identical in size and shape with respect to first C-shaped opening 100. Width 102′ of opening 102 is substantially equal to width 100′ of opening 100.

Fourth gear 12A further defines first 30 and second 31 substantially identical C-shaped grooves therein, but in this embodiment of the invention second C-shaped opening 102 extends across and through second C-shaped groove 31 (FIG. 3). Gear 12A is a solid disc cut and milled with a hub 12A′ on side 136. Around the exterior circumference or edge 132 gear teeth 134 are located for engagement with gears 5, 14.

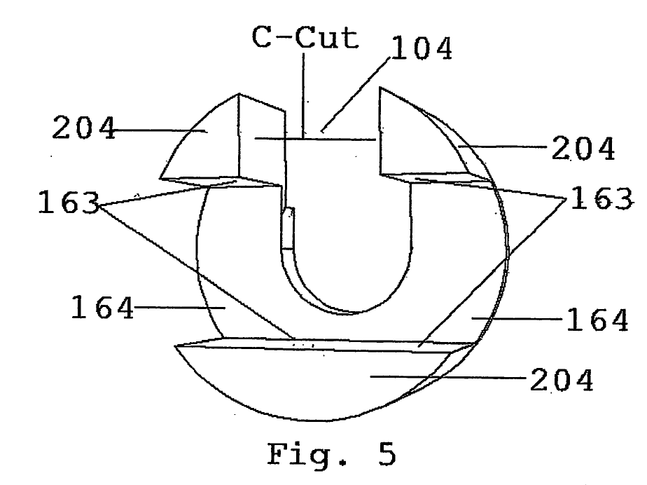

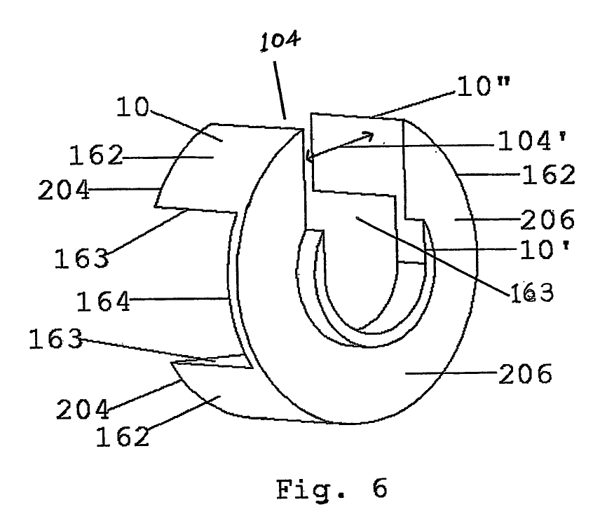

A housing 10 (FIGS. 5 and 6) is rotatably mounted with respect to case 17 and defines a third substantially C-shaped opening 104 substantially identical in size and shape with respect to first and second C-shaped openings 100, 102. Width 104′ of opening 104 is substantially equal to widths 100′, 102′ of openings 100, 102. Housing 10 is a solid disc cut and milled to provide for C-shaped opening 104 as well as hub 10′. Housing 10 is also cut and milled to provide a center cut 163 at a ninety degree angle with respect to C-shaped opening 104, but center cut 163 is provided with a back wall 164.

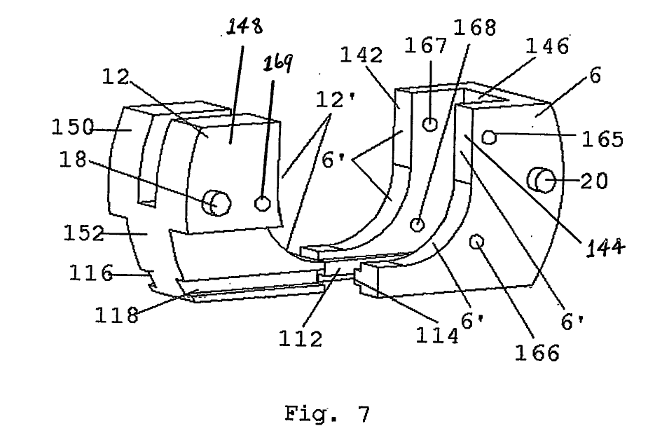

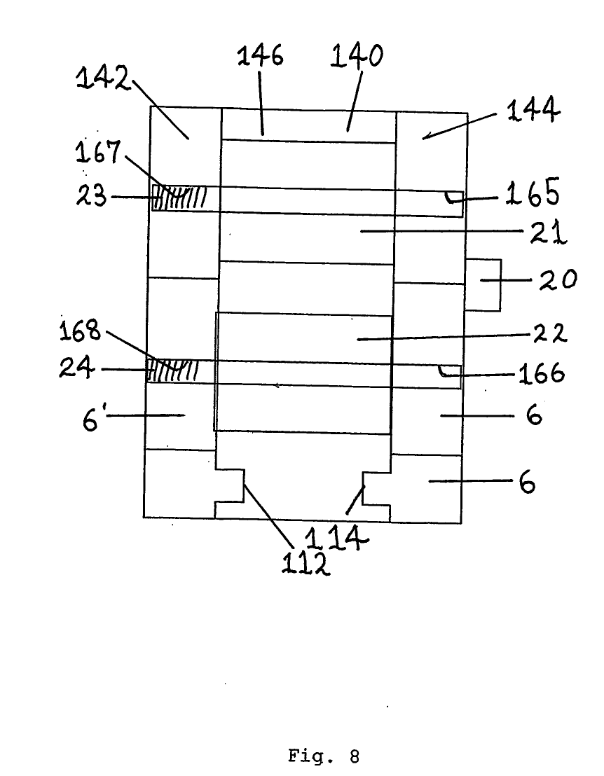

Tube cutter 126 further includes a roller support 6 movably mounted within housing 10 and within center cut 163 of housing 10. Roller support 6 (FIG. 7) defines a first protrusion 20 positioned in sliding relationship within first C-shaped groove 30. Roller support 6 is a solid piece of metal or plastic milled to slidably fit within center cut 163 of housing 10. Protrusion 20 is preferably substantially cylindrical in shape and can slide along within C-shaped groove 30 in forward and backward directions. Roller support 6 further defines mounting holes 165, 166, 167, 168 therein, and first 21 and second 22 cylindrical or circular rollers are axially rotatably mounted on roller support 6 by roller shafts 23, 24, respectively. Shaft 23 is conventionally mounted within mounting holes 165, 167, and shaft 24 is conventionally mounted in mounting holes 166, 168. See FIG. 8.

Rollers 21, 22 are removable when replacement is necessary by unscrewing roller shafts 23, 24 from mounting holes 167, 168, respectively.

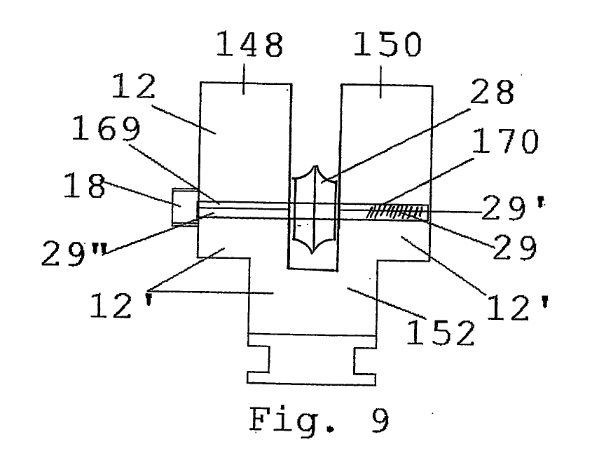

A blade support 12 is movably mounted within housing 10 and defines a second protrusion 18 positioned in sliding relationship within second C-shaped groove 31. See FIG. 7. Blade support 12 is a solid piece of metal or plastic milled to slidably fit into center cut 163 of housing 10 and opposite to roller support 6. Blade support 12 defines two mounting holes 169, 170 therein. See FIG. 9. A blade 28 is axially rotatably mounted on blade support 12 by blade mounting shaft 29 which is positioned within mounting holes 169, 170. Mounting shaft 29 is preferably a solid shaft adapted at one end 29′ to a screwdriver (not shown) and threaded at opposite end 29″ to threadably engage threaded mounting hole 169. Shaft 29 is removable from mounting holes 169, 170 to permit replacement of cutting blade 28, which is a solid sharpened disc axially, rotatably mounted on blade mounting shaft 29.

Roller mounting shafts 23, 24 are similarly configured with respect to roller support mounting holes 165, 166, 167, 168 so that shafts 23, 24 can be removed for replacement of rollers 21, 22.

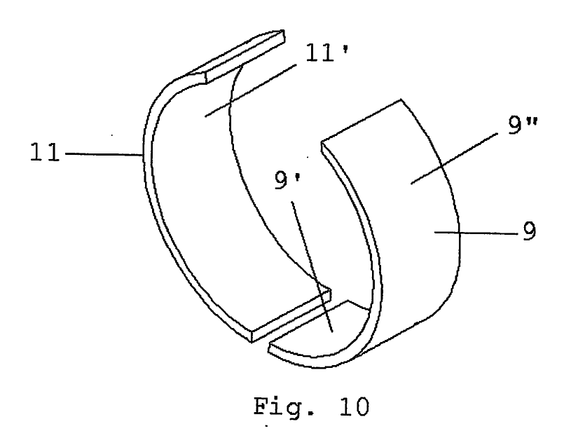

First 9 and second 11 brake elements are held in positions with respect to case 17 and are positioned for contacting housing 10. See FIGS. 4 and 10. Each of brake elements 9, 11 are solid pieces of metal or plastic in the shape of a curved band to fit around the exterior of housing 10. The function of brake elements 9, 11 is to press against the exterior sides or circumference of housing 10 when tube cutter 126 is being used. Brake elements 9, 11 also provide a mounting structure for housing 10. The curvature of brake elements 9, 11 substantially matches the curvature of exterior circumference 162 of housing 10 against which brake elements 9, 11 are slidably positioned. The width of each of brake elements 9, 11 is also approximately the same as the width of exterior circumference 162 of housing 10.

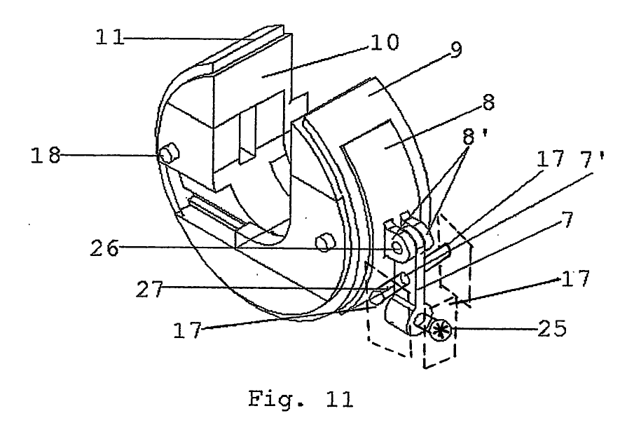

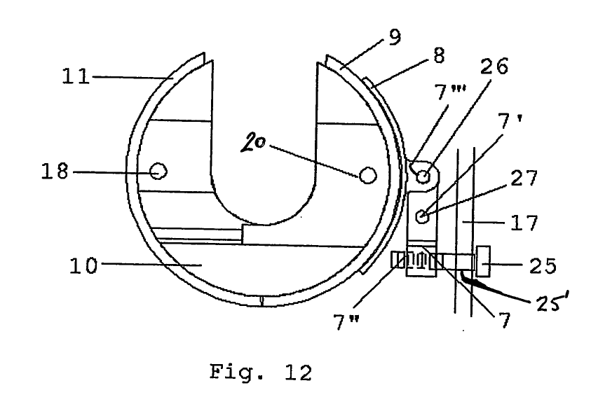

In accordance with this embodiment of the invention, means 7, 8, 25, 26, 27 are provided in operative relationship with first brake element 9 and with case 17 for adjustably exerting force on first brake element 9 and through first brake element 9 on housing 10. See FIGS. 11 and 12. Force exerting means 7, 8, 25, 26, 27 include a lever 7 formed as a solid piece with three holes 7′, 7′, 7′″ therein. Upper hole 7′″ slidably receives attachment shaft 26 therethrough. Center hole 7′ slidably receives fulcrum shaft 27 therethrough, and bottom hole 7″ is threaded to receive set screw 25 therein.

Pressure element 8 is a solid piece of plastic or metal shaped as a curved band, which curve matches the curve of brake elements 9, 11. The convex side of pressure element 8 includes a mounting structure 8′ for receiving and holding attachment shaft 26.

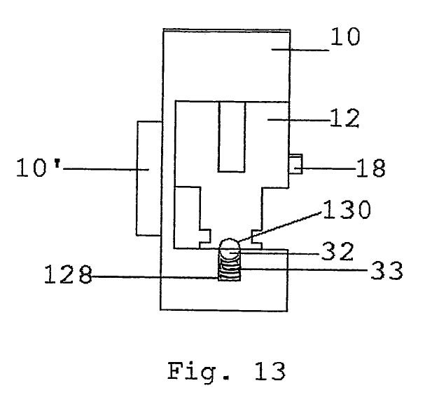

In one embodiment of the invention, means 32, 33 are provided in operative relationship with housing 10 and with blade support 12 for selectively holding blade support 12 in fixed position with respect to housing 10 and for selectively enabling blade support 12 to remove with respect to housing 10 under predetermined conditions. See FIG. 13. In accordance with the invention, holding means 32, 33 include a first opening 128 defined within housing 10, a second opening 130 defined within blade support 12 and located for selective alignment with first opening 128. Holding means 32, 33 further include a compression spring 33 positioned within first opening 128 and a ball bearing 32 positioned in contact with spring 33 and normally positioned simultaneously within first 128 and second 130 openings for holding blade support 12 in a fixed position with respect to housing 10 and for enabling blade support 12 to move with respect to housing 10 when ball bearing 32 exits second opening 130 as blade support 12 and roller support 6 move toward each other when protrusions 18, 20 move into second groove sections 31″, 30″, respectively.

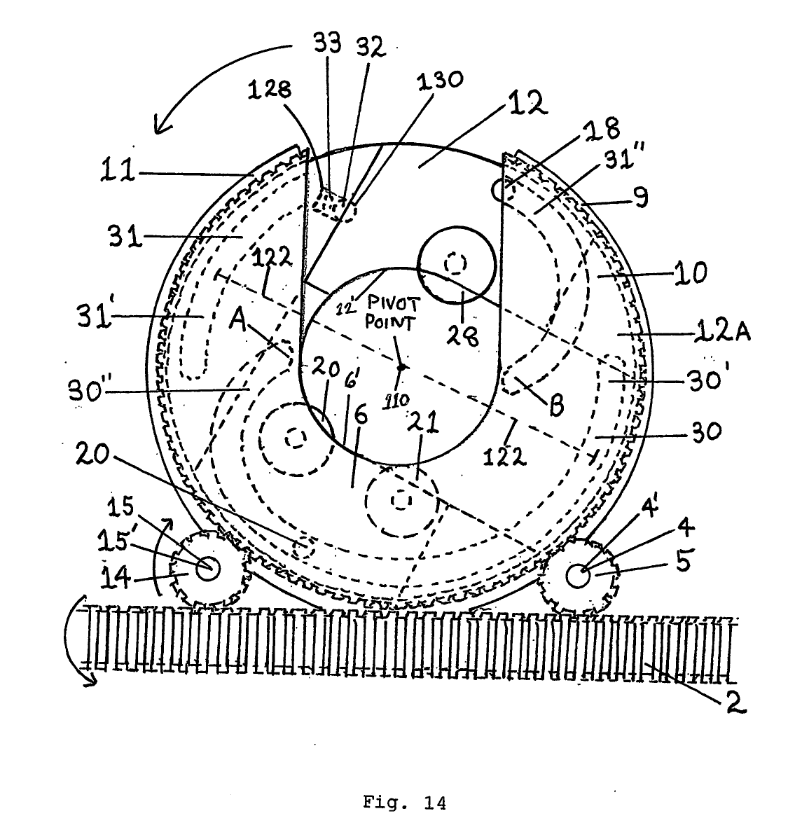

In accordance with the invention, fourth gear 12A, housing 10, roller support 6 and blade support 12 are positioned in relationship with each other for rotation about a central axis 110 of fourth gear 12A as first 2, second 5 and third 14 gears rotate fourth gear 12A in response to activation of motor 16. See FIG. 14. Further, first 30 and second 31 grooves each define first sections 30′, 31′, respectively, defined by a first radius 122 extending from central axis 110 and second sections 30″, 31″, respectively. See FIG. 14.

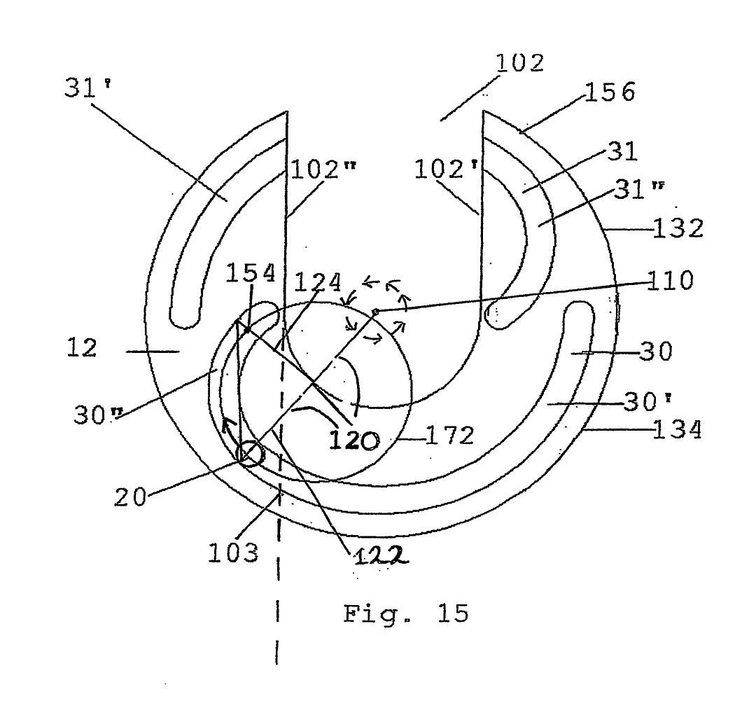

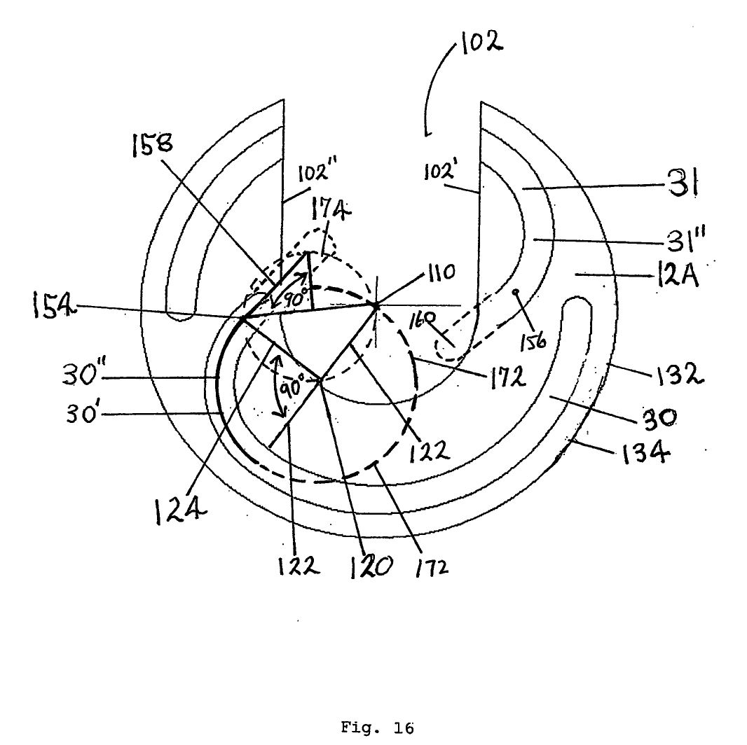

Further in accordance with one embodiment of the invention, second sections 30″, 31″ are each curved and are each at least partially defined by substantially one-quarter of a circumference of a circle 172 formed by a second radius 124 substantially one-half the length of first radius 122. See FIG. 15. In one preferred embodiment, second sections 30″, 31″ each further defines first and second intermediate locations 154, 156, respectively, and second sections 30″, 31″ each further defines end sections 158, 160, respectively, which are substantially straight and which extend along a portion of a line which subtends substantially one-quarter of circumferences of circles 174 formed by diameters extending between central axis 110 and first and second intermediate locations 154, 156, respectively. See FIG. 16.

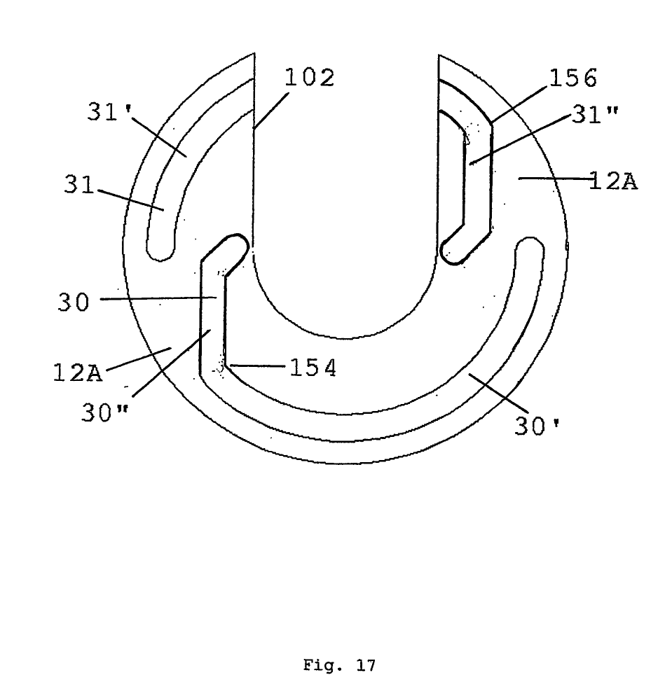

Another preferred embodiment of the invention is illustrated in FIG. 17 wherein second sections 30″, 31″ are each substantially straight and wherein each of second sections 30″, 31″ subtends substantially one-quarter of a circumference of a circle 172 formed by a second radius 124 substantially one-half the length of first radius 122. See FIGS. 16-18.

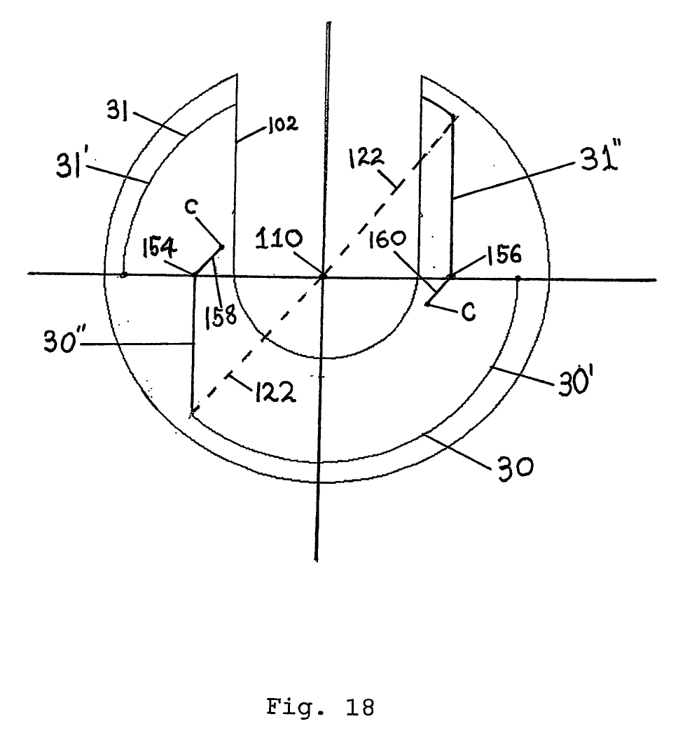

In a further embodiment shown in FIG. 18, second sections 30″, 31″ each further defines first and second intermediate locations 154, 156, respectively, and second sections 30″, 31″ each further defines end sections 158, 160, respectively, which are substantially straight and which extend along a portion of a line which subtends substantially one-quarter of circumferences of circles 174 formed by diameters extending between central axis 110 and first and second intermediate locations 154, 156, respectively. See FIG. 16.

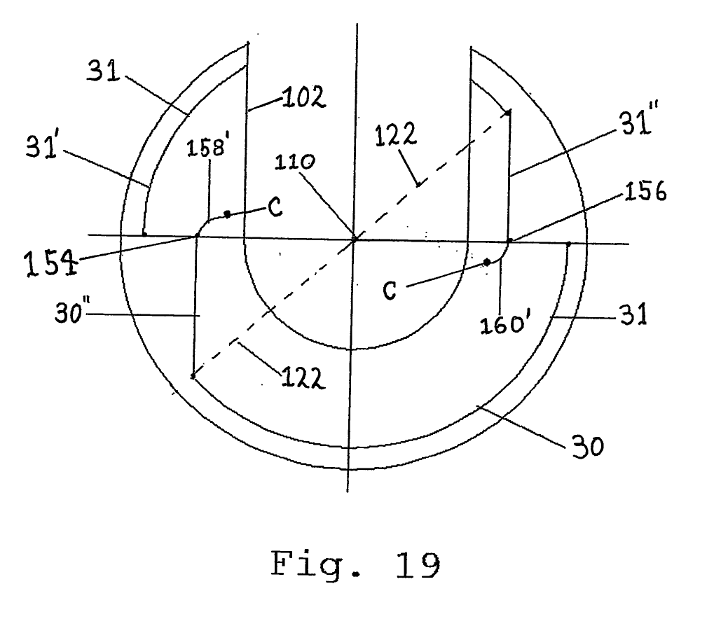

Still a further preferred embodiment is illustrated in FIG. 19 wherein second sections 30″, 31″ each further defines first and second intermediate locations 154, 156, respectively, and wherein second sections 30″, 31″ each further defines end sections 158′, 160′, respectively, which are curved and which are each defined by substantially one-quarter of circumferences of circles 174 formed by diameters extending between central axis 110 and first and second intermediate locations 154, 156, respectively. See FIG. 16

Further in accordance with one preferred embodiment of the invention, second C-shaped opening 102 extends across and through first section 31′ of second groove 31. See FIG. 15.

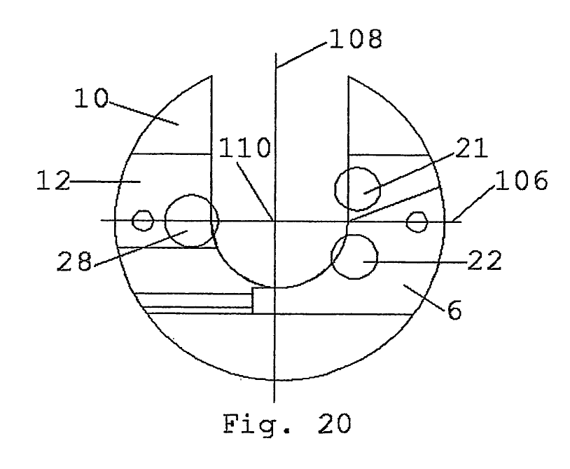

Housing 10, roller support 6 and blade support 12 are configured and sized with respect to each other for enabling roller support 6 and blade support 12 to move only toward and away with respect to each other during operation of tube cutter 126. Housing 10 defines first 106 and second 108 orthogonal axes passing through extended central axis 110 of fourth gear 12A, and blade 28 is substantially bisected by first axis 106 and rollers 21, 22 are spaced substantially equal distances from first axis 106. See FIG. 20.

Roller support 6 defines first 112 and second 114 elongated protrusions, and blade support 12 defines opposed, first 116 and second 118 channels for, respectively, slidably receiving first 112 and second 114 elongated protrusions therein to provide increased stability for tube cutter 126 during its operation. Roller support 6 and blade support 12 also define opposed first 6′ and second 12′ arcuate surfaces, respectively which substantially match third C-shaped opening 104. See FIG. 7.

As shown in FIGS. 11 and 12, force exerting means 7, 8, 25, 26, 27 include pressure element 8 in contacting relationship with first brake element 9. Lever 7 is movably attached to pressure element 8 and defines first opening 7′ therein. A screw 25 is adjustably connected to lever 7 by threadably engaging second opening 7″ within lever 7, and screw 25 extends through an opening 25′ in case 17. A fulcrum shaft 27 is conventionally connected to case 17 and extends in movable relationship through first opening 7′.

Further in accordance with the invention, housing 10 defines a first hub 10′ (FIG. 6) rotatably positioned with respect to case 17 and fourth gear 12A defines a second hub 12A′ (FIG. 2) rotatably positioned with respect to case 17. Housing 10 defines a curved outer surface 10″ or circumference 162, and brake elements 9, 11 are each curved and contact outer surface 10″. Pressure element 8 is also curved and contacts outer convex surface 9″ of first brake element 9.

Fourth gear 12A is disc-shaped and defines an exterior edge 132 having gear teeth 134 therein. Gear 12A defines opposed sides 136, 138 (FIGS. 2 and 3), and hub 12A′ extends from side 136. Grooves 30, 31 are located on opposite side 138 of disc-shaped fourth gear 12A.

Roller support 6 defines first 142 and second 144 opposed and spaced-apart wall elements and a third 146 wall element extending between first 142 and second 144 wall elements. See FIGS. 7 and 8. Rollers 21, 22 are rotatably mounted with respect to and between first 142 and second 144 wall elements. First 23 and second 24 roller shafts extend between first 142 and second 144 wall elements, and rollers 21, 22 are rotatably, axially mounted on roller shafts 23, 24, respectively. Portions of first 142 and second 144 wall elements define first arcuate surfaces 6′.

Blade support 12 defines fourth 148 and fifth 150 opposed and spaced-apart wall elements, and blade 28 is rotatably mounted with respect to and between fourth 148 and fifth 150 wall elements. See FIG. 9. A blade mounting shaft 29 extends between fourth 148 and fifth 150 wall elements, and blade 28 is rotatably, axially mounted on blade shaft 29. A base element 152 is connected to fourth 148 and fifth 150 wall elements, and portions of fourth 148 and fifth 150 wall elements and base element 152 define second arcuate surfaces 12′. Base element 152 is sized and configured to slidably fit between first 142 and second 144 wall elements of roller support 6 as roller support 6 and blade support 12 move toward and away from each other during operation of tube cutter 126.

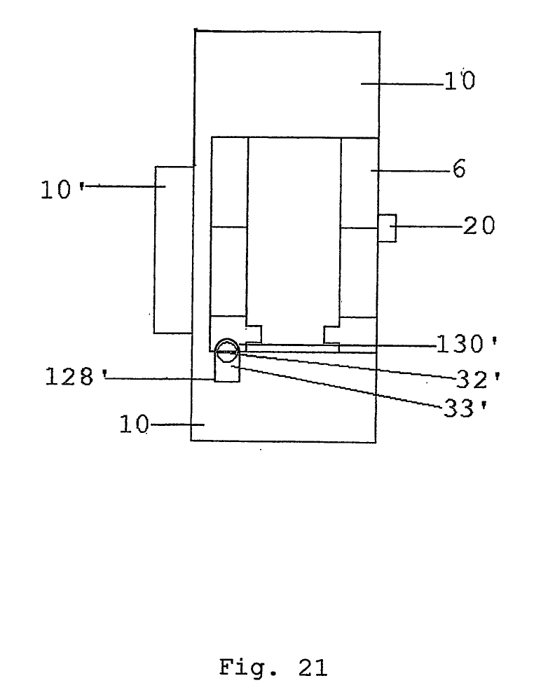

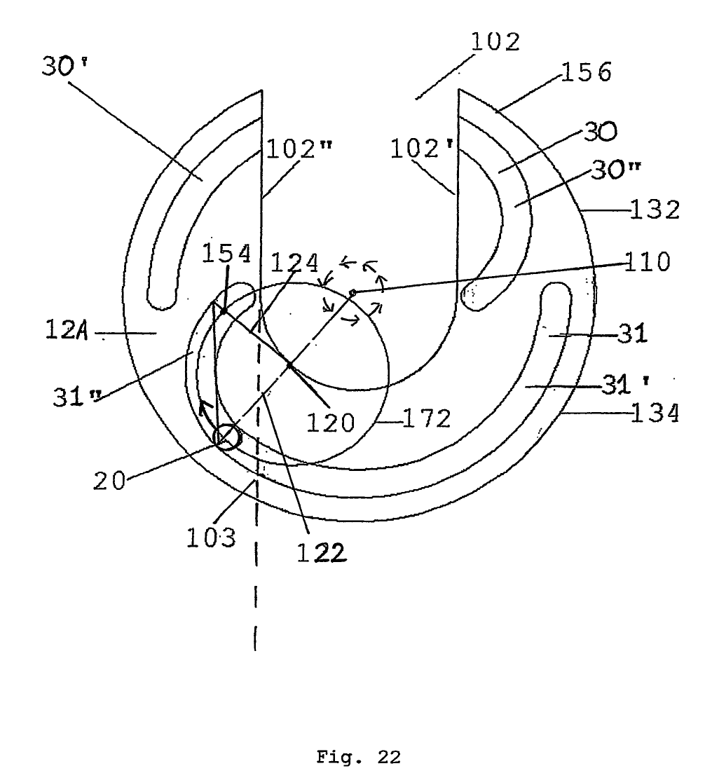

An alternative configuration for tube cutter 126 is illustrated in FIGS. 21 and 22 wherein C-shaped opening 102 in fourth gear 12A extends across and through C-shaped groove 30 instead of extending across and through C-shaped groove 31, as previously described. In this embodiment, protrusion 20 from roller support 6 is slidably positioned within groove 30 instead of within groove 31, as in the previously described embodiment. Likewise, protrusion 18 of blade support 12 is slidably positioned within groove 31 of gear 12A.

In this alternative configuration, means 32, 33 are provided in operative relationship with housing 10 and with roller support 6 for selectively holding roller support 6 in fixed position with respect to housing 10 and for selectively enabling roller support 6 to move with respect to housing 10 under predetermined conditions.

More specifically, in this alternative configuration a first opening 128′ is defined within housing 10, and a second opening 130′ is defined within roller support 6 and is located for selective alignment with first opening 128′. See FIG. 21. A compression spring 33′ is positioned within first opening 128′ and a ball bearing 32′ is positioned in contact with spring 33′ and is normally positioned simultaneously within first 128′ and second 130′ openings for holding roller support 6 in fixed position with respect to housing 10 and for enabling roller support 6 to move with respect to housing 10 when ball bearing 32′ exits second opening 130′ as second roller support 6 and blade support 12 move toward each other when protrusions 18, 20 move into second groove sections 31″, 30″, respectively. In all other respects, this embodiment is identical with respect to previous embodiments described herein.

Second C-shaped opening 102 in gear 12A defines first and second opposed spaced-apart walls 102′, 102″, and second sections 31″ (FIG. 15) and 30″ (FIG. 22) are located between first wall 102′ and edge 132 of gear 12A. First sections 30″ (FIG. 15) and 31″ (FIG. 22) are located between an imaginary straight line extension 103 of second wall 102″ and edge 132.

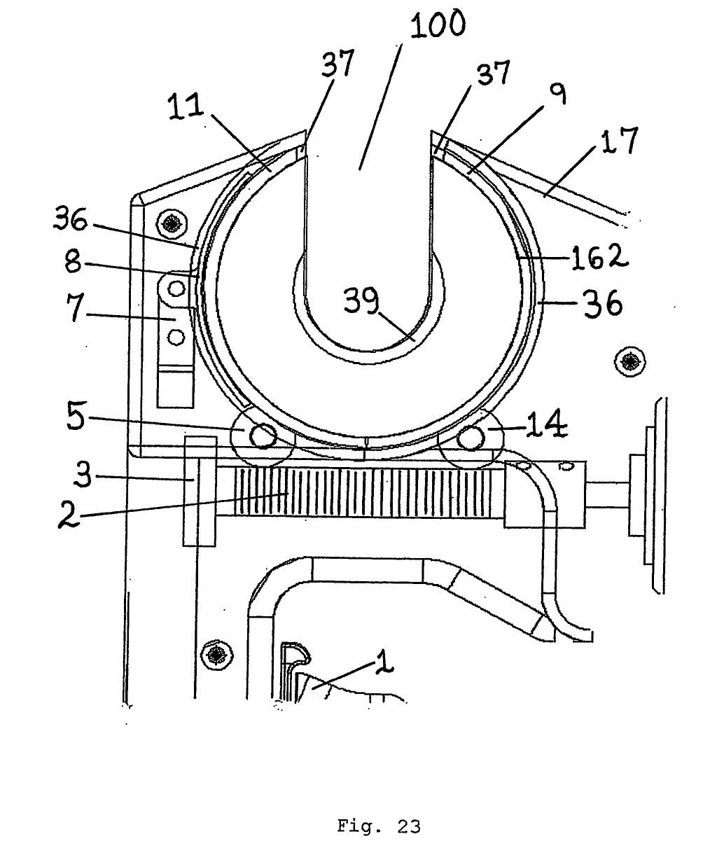

In several embodiments of the invention, tube cutter 126 further includes brake elements retaining members 37, 37′ connected to case 17 adjacent to opening 100 for limiting movement of brake elements 9, 11, respectively, as housing 10 rotates about central axis 110. See FIG. 23.

Housing 10 further defines an exterior circumference 162 (see FIG. 6) and brake elements 9, 11 each defines an interior curved surface 9′, 11′, respectively, (see FIG. 10) which contact exterior circumference 162. The combined lengths of curved surfaces 9′, 11′ are less than exterior circumference 162 to prevent binding together of brake elements 9, 11 as tube cutter 126 operates and as housing 10 rotates.

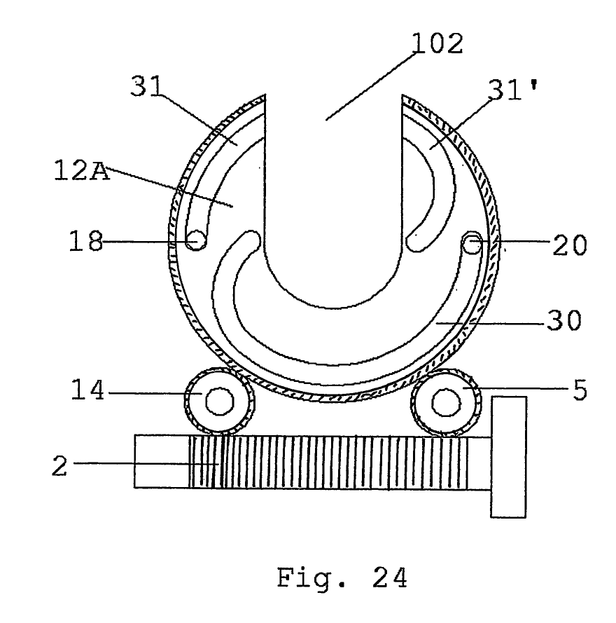

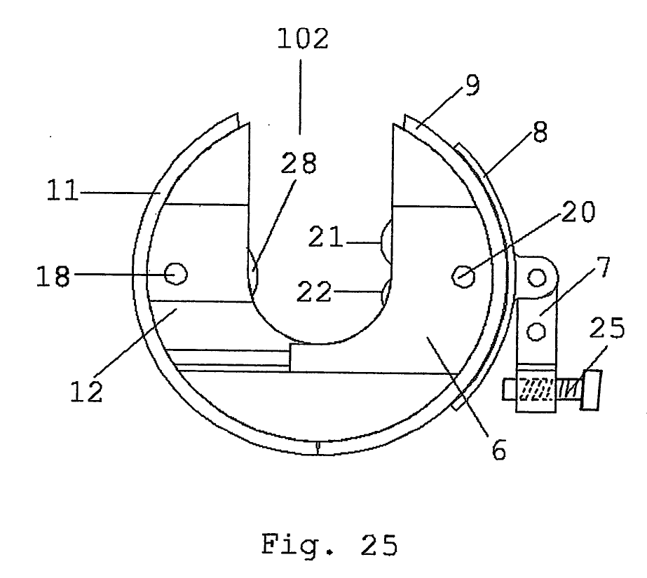

In operation and use, a tube or pipe 176 is placed within C-shaped opening 100 in case 17. Handle 17′ is grasped by the operator, and motor 16 is activated in a forward direction by trigger assembly 1. First gear 2 rotates in a forward direction in response to activation of motor 16, and gears 5, 14 are rotated by gear 2. Rotation of gears 5, 14, in turn, causes rotation of fourth gear 12A in a forward direction. See FIGS. 24-27. FIGS. 24 and 25 show tube cutter 126 in the “start position” or the “at rest position”.

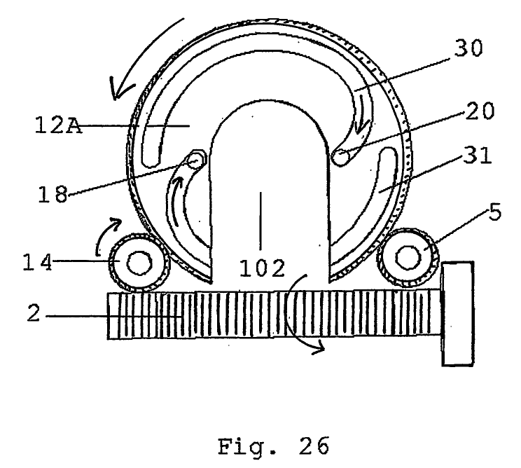

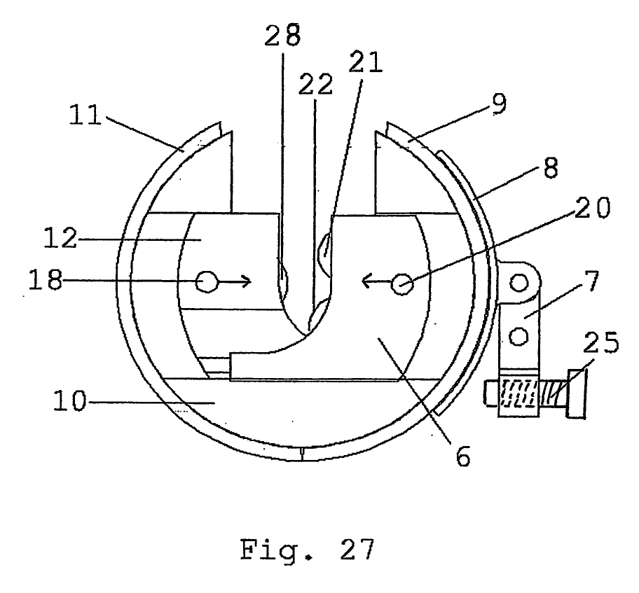

As gears 2, 5, 14 and 12A move in their forward directions, protrusions 18, 20 are forced along and within C-shaped grooves 31, 30, respectively. FIGS. 26 and 27 illustrate when protrusions 18, 20 have moved to the opposite ends of C-shaped grooves 31, 30. This movement of protrusions 18, 20 within C-shaped grooves 31, 30 is caused by brake pads 9, 11 restricting rotational movement of housing 10 while gear 12A continues to rotate in its forward direction and faster than the rotation of housing 10.

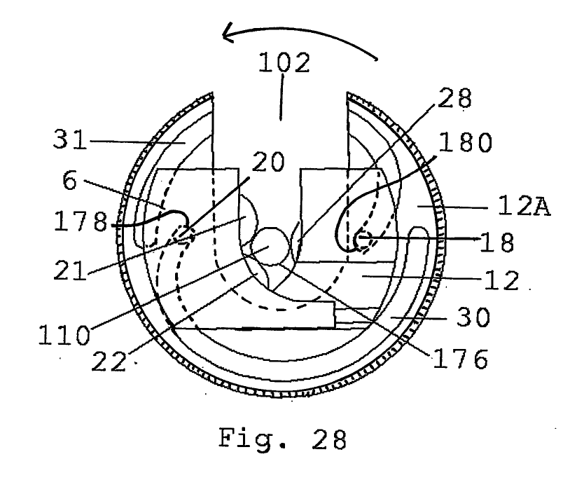

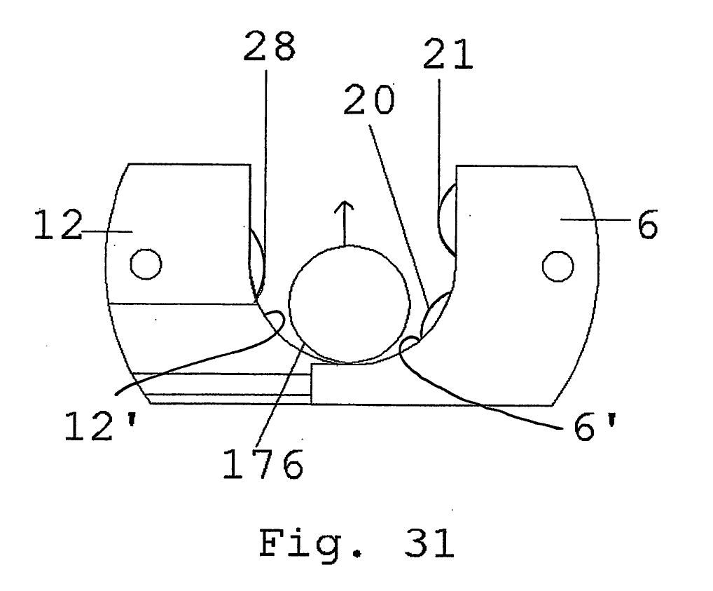

As protrusions 18, 20 move toward each other within grooves 31, 30, respectively, blade support 12 and roller support 6 are caused to move toward each other within housing 10 until blade 28 and rollers 21, 22 contact pipe 176. See FIGS. 28, 31 and 32. Gear 12A continues to spin and protrusions 18, 20 are held at the ends of C-shaped grooves 31, 30, as shown in FIGS. 26 and 28.

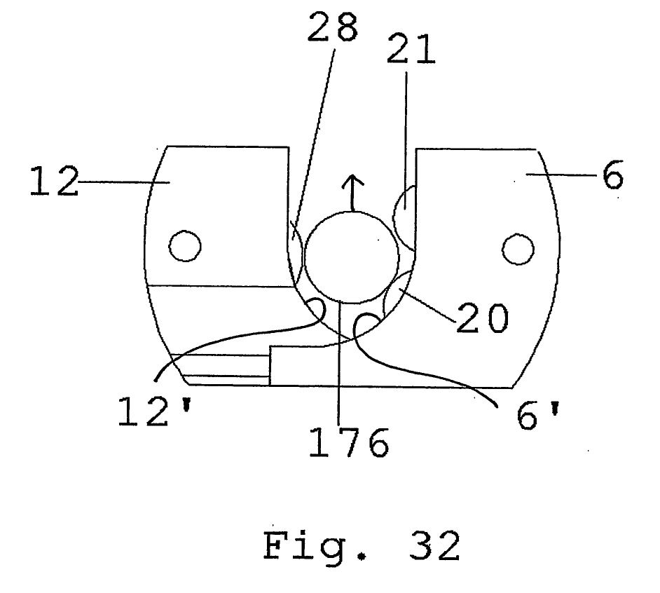

Housing 10 is also rotating about axis 110, but housing 10 is rotating more slowly than gear 12A because of the braking effect of brake elements 9, 11. Set screw 25 is positioned tightly against the exterior of case 17, and pressure lever 7 forces pressure pad 8 to exert force on spinning housing 10 via brake elements 9, 11. This braking action by brake elements 9, 11 on housing 10 slows rotation of housing 10 and also slows rotation of roller and blade supports 6, 12 which are inside housing 10. This forces blade 28 and rollers 21, 22 to rotate around pipe 176 and results in cutting the pipe. See FIGS. 28 and 32.

As protrusions 18, 20 advance along C-shaped grooves 31, 30, they will be continually forced toward ends 178, 180 of grooves 30, 31, respectively. See FIG. 28. Depending upon the diameter of pipe 176, blade 28 and rollers 21, 22 will contact the sides of tubular member or pipe 176 before protrusions 18, 20 reach the ends 180, 178 of grooves 31, 30, respectively. As gear 12A continues to rotate and as housing 10 is continued to be restricted in its rotation by brake elements 9, 11, the force on blade 28 and roller elements 21, 22 increases as they spin around tube or pipe 176. As blade 28 and rollers 21, 22 continue to spin around tube 176, the forces exerted increase as protrusions 18, 20 are urged toward ends 180, 178 of grooves 31, 30, and tube 176 is cut.

Curved or arcuate surfaces 6′, 12′ of supports 6, 12, respectively, work together as supports 6, 12 move toward each other to force tube 176 upwardly until tube 176 is positioned between rollers 20, 21 and opposite blade 28. See FIG. 32. In this position, blade 28 presses against tube 176 and holds it in place against rollers 20, 21. The maximum diameter of the tube or pipe 176 which can be cut by tube cutter 126 is approximately the same diameter as width 100′ of C-shaped opening 100 in case 17. The minimum diameter of the pipe or tube 176 which can be cut by tube cutter 126 is approximately the minimum distance between rollers 20, 21 and blade 28 at which blade 28 and rollers 20, 21 can contact the exterior surface of tube or pipe 176.

Tube cutter 126 is then returned to the starting position shown in FIGS. 24 and 25 by reversing the direction of motor 16 via conventional trigger assembly 1. The movement of elements of tube cutter 126 described above and illustrated in FIGS. 24-28 is then reversed, and tube cutter 126 returns to the “start position” or the “at rest position” shown in FIGS. 24 and 25. When the tool is returned to the “start position” or the “at rest position”, the operator releases trigger assembly 1 causing further movement of tube cutter 126 to stop.

Adjustment of the braking forces on housing 10 by brake elements 9, 11, in one invention embodiment is accomplished by turning set screw 25. Set screw 25 passes through case 17 and the head of set screw 25 is located on the outside of the exterior of case 17. Set screw 25 uses the exterior case 17 as a foundation to exert force. When set screw 25 is turned in a first direction, pressure lever 7 is pulled toward the head of set screw 25. This causes the end of pressure lever 7, which is attached to pressure pad 8, to move toward brake element 9 upon which pressure pad 8 rests. Thus, by adjusting the position of set screw 25, the forces exerted by pressure pad 8 on brake elements 9, 11 can be adjusted to adjust the rotation of housing 10 during operation of tube cutter 126. See FIGS. 11 and 12.

In the embodiment shown in FIGS. 13, and 24-28, blade support 12 and protrusion 18 must pass across C-shaped opening 102 in gear 12A as tube cutter 126 is operated. Blade support 12 would dislodge inside tube cutter 126 if blade support 12 were not held in place while passing across C-shaped opening 102. FIG. 13 illustrates how this is accomplished. Opening 128 within housing 10 and opening 130 in blade support 12 have a compression spring 33 and a ball bearing 32 positioned within openings 128, 130, as shown in FIG. 13. When tube cutter 126 is in the start position, openings 128, 130 are in alignment with each other. As forces are increased upon blade support 12 during operation of tube cutter 126 as protrusion 18 is forced along groove 31, blade support 12 slides within housing 10 toward roller support 6. As blade support 12 slides with respect to housing 10, it slides over ball bearing 32 and forces ball bearing 32 downwardly into opening 128. When openings 128, 130 are again aligned when tube cutter 126 is returned to its start position, ball bearing 32 is forced upwardly by compression spring 33 and back into opening 130 to hold blade support 12 in place.

Because of the configurations of grooves 30, 31, blade support 12 and roller support 6 are only urged from their start positions and toward each other as protrusions 18, 20 enter sections 31′, 30′, respectively. Thus, blade support 12 is held in its start position by ball bearing 32 and spring 33 until after protrusion 18 has passed across C-shaped opening 102 of gear 12A and until protrusion 18 has entered section 31′ of groove 31.

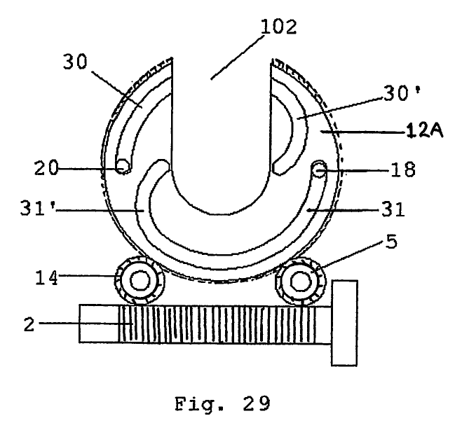

An alternative configuration is illustrated in FIGS. 21 and 29 wherein protrusion 20 of roller support 6 is positioned within groove 30 and wherein protrusion 18 of blade support 12 is positioned within groove 31. In this embodiment, roller support 6 is held in position with respect to housing 10 as protrusion 20 passes across C-shaped opening 102 by ball bearing 32′ and compression spring 33′ positioned within openings 130′ and 128′ located within roller support 6 and housing 10, respectively.

Brake elements 9, 11 are positioned within case 17 and in contact with curved interior walls 36 of case 17. See FIG. 23. When housing 10 is inserted within tube cutter 126, its exterior side wall 162 is positioned against interior surfaces 9′, 11′ of brake elements 9, 11. This forces brake elements 9, 11 against formed interior walls 36 of case 17. Housing 10 can spin within this containment even though there is no space between brake elements 9, 11 at exterior surface 162 of housing 10 that is visible to the naked eye or which is felt by trying to wobble housing 10. While in this position, housing 10 spins freely without play.

Brake pads 9, 11 are shorter in combined length than exterior circumference 162 of housing 10 so they do not bind together when pressure is applied to them. The shorter combined length will allow them to be dragged along with housing 10 as it spins before brake elements 9, 11 movement is stopped by retaining members 37, 37′.

When pressure pad 8 exerts force on brake elements 9, 11, there is no visible movement of brake elements 9, 11. However, the force from pressure pad 8 is transferred from brake element 9 to housing 10 and to brake element 11.

Case 17 is formed with interior walls 36 which secure the various elements of tube cutter 126 while other elements use case 17 as a mounting foundation for a shaft or hub.

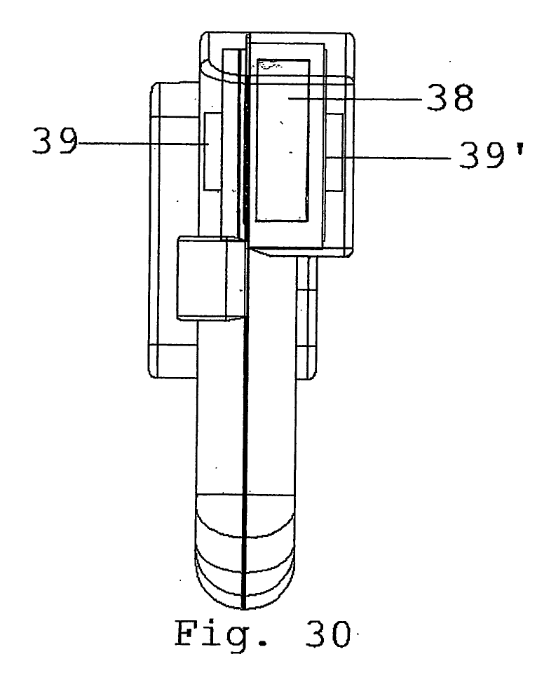

Interior wall 36 which secures brake element 11 defines a substantially rectangular opening 38 in which pressure pad 8 is positioned. See FIG. 30. Hub 10′ of housing 10 and hub 12A′ of gear 12A are rotatably positioned within channels 39, 39′ formed within case 17. See FIG. 30. This secures housing 10 and gear 12A inside case 17. Housing 10 is also secured and held within case 17 by its position between brake elements 9, 11.

The different curved and straight configurations of groove sections 30′, 31′ and end sections 158, 158′, 160 and 160′ are provided to enable tube cutter 126 to cut the broadest range of tube or pipe diameters in the most efficient ways.

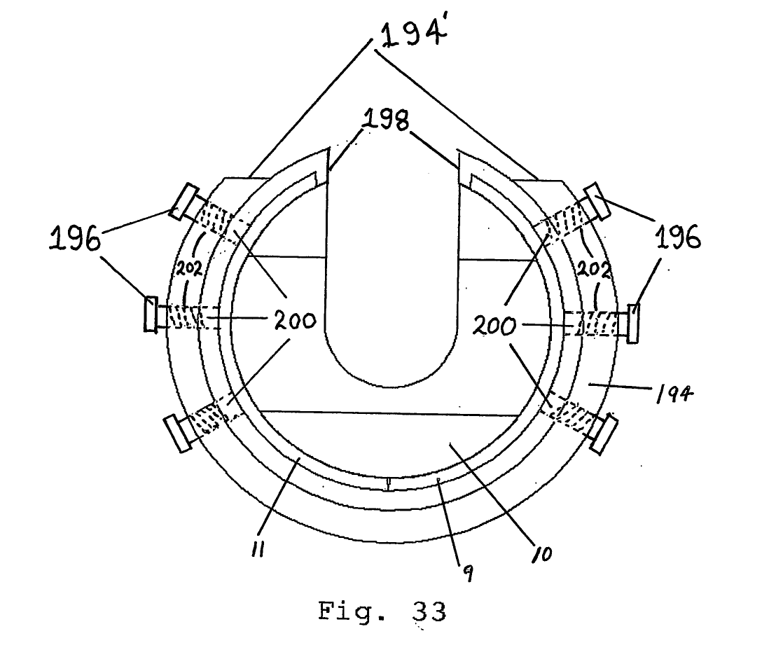

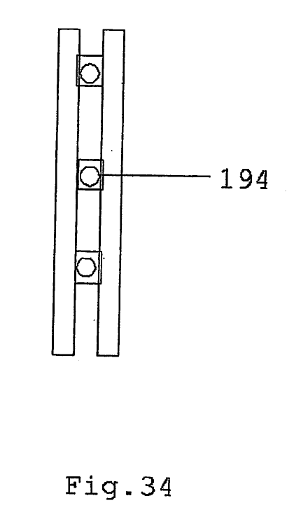

Another embodiment of the invention is shown in FIGS. 33 and 34. In this embodiment, a ring 194 has an open section 194′. Ring 194 is fastened to an interior wall 198 of case 17 through openings 200 in wall 198 which receive bolts 196 therethrough. Bolts 196 threadably pass through threaded openings 202 in ring 194, and the ends of bolts 196 contact exterior, convex surfaces of brake elements 9, 11. When bolts 196 are tightened, they apply force to brake elements 9, 11, to slow rotation of housing 10 with respect to case 17 as tube cutter 126 is operated. Because bolts 196 pass through interior wall 198 of case 17, ring 194 is held in fixed position with respect to case 17 as housing 10 rotates. The distance across open section 194′ of ring 194 is at least equal to or greater than width 100′ of C-shaped opening 100 in case 17.

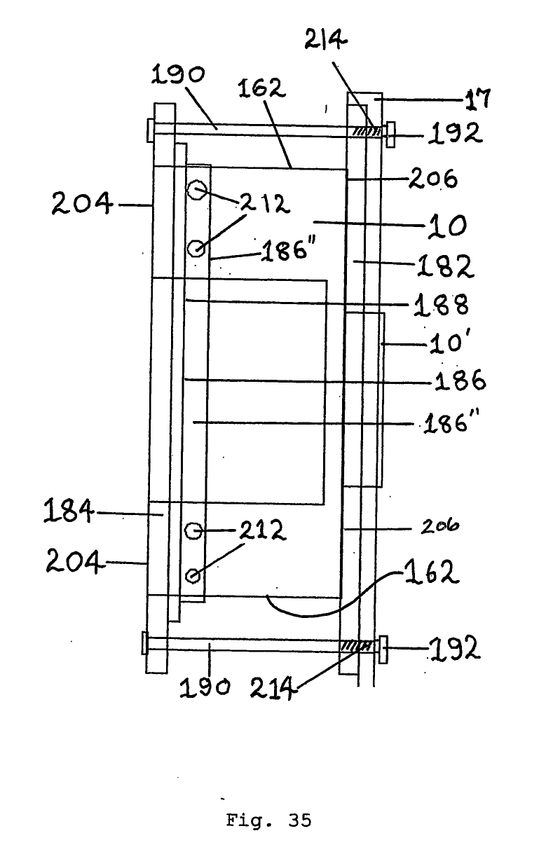

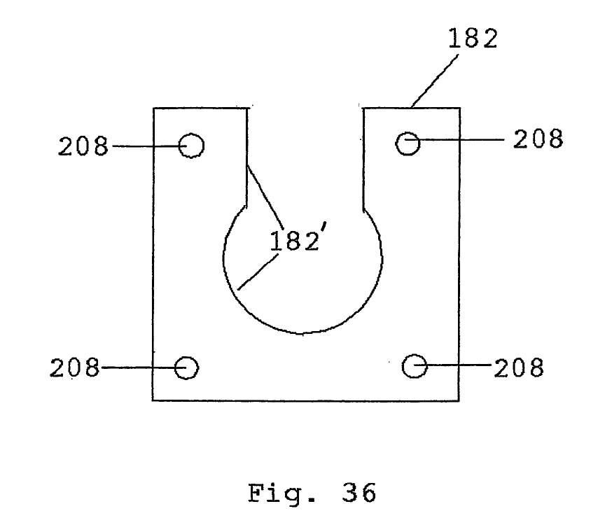

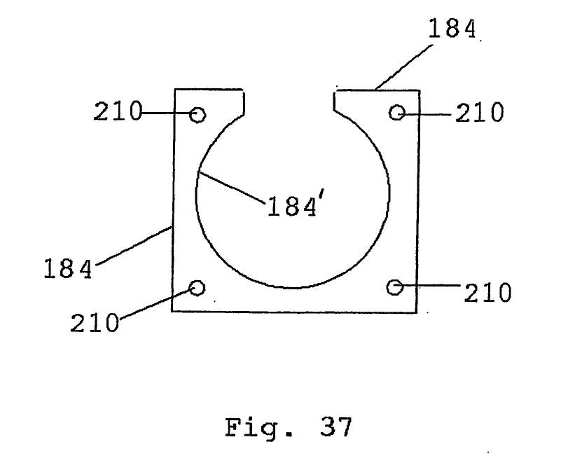

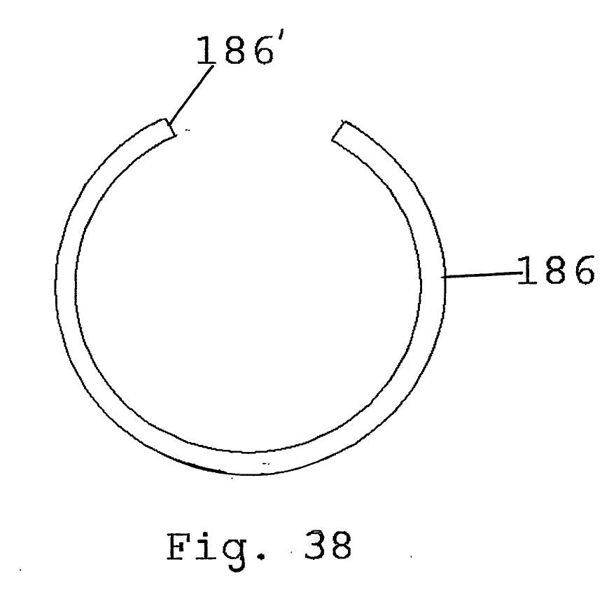

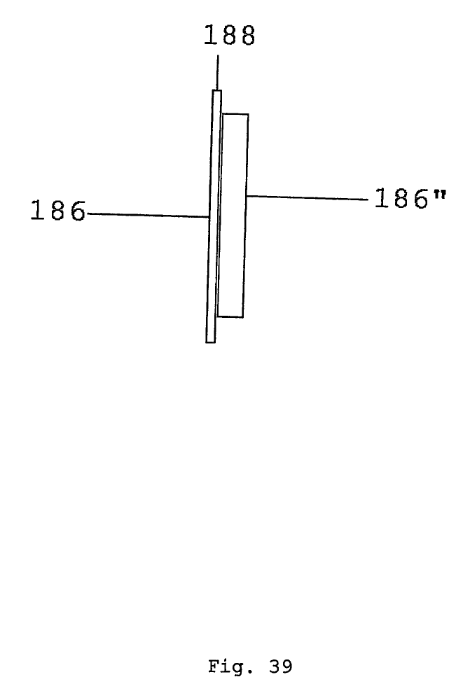

A further embodiment of the invention is illustrated in FIGS. 35-39. In this embodiment, means 182, 184, 186, 188, 190, 192 are provided in operative relationship with housing 10 and with case 17 for retarding rotation of housing 10 with respect to case 17 during operation of tube cutter 126. More specifically, this embodiment includes a hub plate 182 which is a flat plate with a circular cut 182′ therein configured to fit around hub 10′ of housing 10. Cut 182′ has a portion substantially identical in size with respect to width 100′ of C-shaped opening 100 in case 17.

This embodiment further includes a housing plate 184 defining a circular cut 184′ therein and wherein cut 184′ is configured and sized to fit around exterior circumference 162 of housing 10.

This invention embodiment further includes a ring 186 sized and configured to fit around circumference 162 of housing 10 and defining an opening 186′ within ring 186 which is sized substantially equal to width 100′ of C-shaped opening 100 in case 17. Ring 186 further defines a flange 188. A portion 186″ of ring 186 is fastened to exterior circumference 162 of housing 10 by screws 212, or other conventional means. Flange portion 188 of ring 186 is pressed against housing plate 184, and housing plate 184 and hub plate 182 are connected together and are connected to case 17 by bolts 190 and nuts 192. Bolts 190 and nuts 192, when tightened, pull housing plate 184 and hub plate 182 toward each other so that housing plate 184 is tightened against flange 188 of ring 186.

Ring 186 is fastened to housing 10 with opening 186′ in alignment with C-shaped opening 100 in case 17 and with C-shaped opening 104 in housing 10. Ring 186 is preferably secured at a location inwardly from side 204 of housing 10 a distance which is substantially the same thickness as that of housing plate 184. Hub plate 182 is then placed at the hub side 206 of housing 10 with cut 182′ in alignment with C-cut 104 in housing 10 and with hub 10′ positioned within circular cut 182′. Housing plate 184 is then placed against flange 188 of ring 186 with exterior circumference 162 of housing 10 positioned within cut 184′ of housing plate 184. Mounting bolts 190 are then placed through mounting holes 208, 210 in hub plate 182 and housing plate 184, respectively, and through mounting holes 214 in case 17. Bolts 190 are then tightened into place with nuts 192. As housing 10 spins during operation of tube cutter 126, braking pressure is applied to housing 10 where flange 188 contacts housing plate 184 and where hub plate 182 contacts housing 10.

The invention in its broader aspects is not limited to the specific details shown and described, and departures may be made from such details without departing from the principles of the invention and without sacrificing its chief advantages.

1. A portable, hand-held, motor-driven, tube cutter (126), comprising:
an exterior case (17) having a handle (17′) and defining a first substantially C-shaped opening (100) therein having a width (100′) of a first predetermined distance;
an electric motor (16) mounted within said case (17);
means (1) in operative relationship with said motor (16) and mounted on said case (17) for selectively activating said motor (16) in forward and reverse directions;
a first gear (2) connected to said motor (16);
a bearing (3) mounted within said case (17) and rotatably supporting said first gear (2);
second (5) and third (14) gears of substantially identical dimensions, rotatably mounted within said case (17), centers (5′, 14′) of said second (5) and third (14) gears, respectively, spaced apart from each other by a second pre-determined distance at least as great as said first predetermined distance (100′) and engaging said first gear (2);
a fourth gear (12A) rotatably mounted within said case (17) and engaging said second (5) and third (14) gears;
said fourth gear (12A) defining a second substantially C-shaped opening (102) substantially identical in size and shape with respect to said first C-shaped opening (100);
said fourth gear (12A) further defining first (30) and second (31) substantially identical C-shaped grooves therein, but with said second C-shaped opening (102) extending across and through said second C-shaped groove (31);
a housing (10) rotatably mounted with respect to said case (17) and defining a third substantially C-shaped opening (104) substantially identical in size and shape with respect to said first (100) and second (102) C-shaped openings;
a roller support (6) movably mounted within said housing (10) and defining a first protrusion (20) positioned in sliding relationship within said first C-shaped groove (30);
first (21) and second (22) rollers rotatably mounted on said roller support (6);
a blade support (12) movably mounted within said housing (10) and defining a second protrusion (18) positioned in sliding relationship within said second C-shaped groove (31);
a blade (28) rotatably mounted on said blade support (12);
first (9) and second (11) brake elements held in positions with respect to said case (17) and positioned for contacting said housing (10);
means (7, 8, 25, 26, 27 or 194, 196) in operative relationship with said first brake element (9) and with said case (17) for adjustably exerting force on said first brake element (9) and through said first brake element (9) on said housing (10);
means (32, 33) in operative relationship with said housing (10) and with said blade support (12) for selectively holding said blade support (12) in fixed position with respect to said housing (10) and for selectively enabling said blade support (12) to move with respect to said housing (10) under predetermined conditions;
said fourth gear (12A), said housing (10), said roller support (6) and said blade support (12) positioned in relationship with each other for rotation about a central-axis (110) of said fourth gear (12A) as said first (2), second (5) and third (14) gears rotate said fourth gear (12A) in response to activation of said motor (16); and
said first (30) and second (31) grooves each defining first sections (30′, 31′), respectively, defined by a first radius (122) extending from said central axis (110) and second sections (30″, 31″), respectively.

2. A tube cutter (126) as in claim 1 wherein said second sections (30″, 31″) are each curved and are each at least partially defined by substantially one-quarter of a circumference of a circle (172) formed by a second radius (124) substantially one-half the length of said first radius (122).

3. A tube cutter (126) as in claim 2 wherein said second sections (30″, 31″) each further defines first and second intermediate locations (154, 156), respectively, and wherein said second sections (30″, 31″) each further defines end sections (158, 160), respectively, which are substantially straight and which extend along a portion of a line which subtends substantially one-quarter of circumferences of circles (174) formed by diameters extending between said central axis (110) and said first and second intermediate locations (154, 156), respectively.

4. A tube cutter (126) as in claim 1 wherein said second sections (30″, 31″) are each substantially straight and wherein each of said second sections (30″, 31″) subtends substantially one-quarter of a circumference of a circle (172) formed by a second radius (124) substantially one-half the length of said first radius (122).

5. A tube cutter (126) as in claim 4 wherein said second sections (30″, 31″) each further defines first and second intermediate locations (154, 156), respectively, and wherein said second sections (30″, 31″) each further defines end sections (158, 160), respectively, which are substantially straight and which extend along a portion of a line which subtends substantially one-quarter of circumferences of circles (174) formed by diameters extending between said central axis (110) and said first and second intermediate locations (154, 156), respectively.

6. A tube cutter (126) as in claim 4 wherein said second sections (30″, 31″) each further defines first and second intermediate locations (154, 156), respectively, and wherein said second sections (30″, 31″) each further defines end sections (158′, 160′), respectively, which are curved and which are each defined by substantially one-quarter of circumferences of circles (174) formed by diameters extending between said central axis (110) and said first and second intermediate locations (154, 156), respectively.

7. A tube cutter (126) as in claim 1 wherein said second C-shaped opening (102) extends across and through said first section (31′) of said second groove (31).

8. A tube cutter (126) as in claim 7 wherein said housing (10), said roller support (6) and said blade support (12) are configured and sized with respect to each other for enabling said roller support (6) and said blade support (12) to move only toward and away with respect to each other.

9. A tube cutter (126) as in claim 8 wherein said housing (10) defines first (106) and second (108) orthogonal axes passing through said extended central axis (110) of said fourth gear (12A) and wherein said blade (28) is substantially bisected by said first axis (106) and said rollers (21, 22) are spaced substantially equal distances from said first axis (106).

10. A tube cutter (126) as in claim 9 wherein said roller support (6) defines opposed, first (112) and second (114) elongated protrusions and wherein said blade support (12) defines opposed, first (116) and second (118) channels for, respectively, slidingly receiving said first (112) and second (114) elongated protrusions therein.

11. A tube cutter (126) as in claim 10 wherein said roller support (6) and said blade support (12) define opposed first (6′) and second (12′) arcuate surfaces, respectively, which substantially match said third C-shaped opening (104).

12. A tube cutter (126) as in claim 11 wherein said holding means (32, 33) include:
a first opening (128) defined within said housing (10);
a second opening (130) defined within said blade support (12) and located for selective alignment with said first opening (128);
a compression spring (33) positioned within said first opening (128); and
a ball bearing (32) positioned in contact with said spring (33) and positioned simultaneously within said first (128) and second (130) openings for holding said blade support (12) in fixed position with respect to said housing (10) and for enabling said blade support (12) to move with respect to said housing (10) when said ball bearing (32) exits said second opening (130) as said blade support (12) and said roller support (6) move toward each other when said protrusions (18, 20) move into said second groove sections (31″, 30″), respectively.

13. A tube cutter (126) as in claim 12 wherein said force exerting means (7, 8, 25, 26, 27) include:
a pressure element (8) in contacting relationship with said first brake element (9);
a lever (7) movably attached to said pressure element (8) and defining a first opening (7′) therein;
a screw (25) adjustably connected to said lever (7) and extending through said case (17); and
a fulcrum shaft (27) connected to said case (17) and extending in movable relationship through said opening (7′).

14. A tube cutter (126) as in claim 13 wherein said housing (10) defines a first hub (10′) rotatably positioned with respect to said case (17) and wherein said fourth gear (12A) defines a second hub (12A′) rotatably positioned with respect to said case (17).

15. A tube cutter (126) as in claim 14 wherein said housing (10) defines a curved outer surface (10″), wherein said brake elements (9, 11) are each curved and contact said outer surface (10″) and wherein said pressure element (8) is curved and contacts said first brake element (9).

16. A tube cutter (126) as in claim 15 wherein said fourth gear (12A) is substantially disc-shaped defining an exterior edge (132) having gear teeth (134) therein and defining opposed sides (136, 138) and wherein said hub (12A′) and said grooves (30, 31) are located on said opposite sides (136, 138), respectively, of said disc-shaped fourth gear (12A).

17. A tube cutter (126) as in claim 16 wherein said roller support (6) defines first (142) and second (144) opposed and spaced-apart wall elements and a third (146) wall element extending between said first (142) and second (144) wall elements, and wherein said rollers (21, 22) are rotatably mounted with respect to and between said first (142) and second (144) wall elements.

18. A tube cutter (126) as in claim 17 further including first (23) and second (24) roller shafts extending between said first (142) and second (144) wall elements, and wherein said rollers (21, 22) are rotatably mounted on said roller shafts (23, 24), respectively.

19. A tube cutter (126) as in claim 18 wherein said first (142) and second (144) wall elements define said first arcuate surfaces (6′).

20. A tube cutter (126) as in claim 19 wherein said blade support (12) defines fourth (148) and fifth (150) opposed and spaced-apart wall elements and wherein said blade (28) is rotatably mounted with respect to and between said fourth (148) and fifth (150) wall elements.

21. A tube cutter (126) as in claim 20 further including a blade mounting shaft (29) extending between said fourth (148) and fifth (150) wall elements, and wherein said blade (28) is rotatably mounted on said blade shaft (29).

22. A tube cutter (126) as in claim 21 further including a base element (152) connected to said fourth (148) and fifth (150) wall elements and wherein said fourth (148) and fifth (150) wall elements and said base element (152) define said second (12′) arcuate surfaces.

23. A tube cutter (126) as in claim 22 wherein said base element (152) is sized and configured to slidably fit between said first (142) and second (144) wall elements as said roller support (6) and said blade support (12) move toward and away from each other.

24. A portable, hand-held, motor-driven, tube cutter (126), comprising:
an exterior case (17) having a handle (17′) and defining a first substantially C-shaped opening (100) therein;
an electric motor (16) mounted within said case (17);
means (1) in operative relationship with said motor (16) and mounted on said case (17) for selectively activating said motor (16) in forward and reverse directions;
a first gear (2) connected to said motor (16);
a bearing (3) mounted within said case (17) rotatably supporting said first gear (2);
second (5) and third (14) gears of substantially identical dimensions, rotatably mounted within said case (17), and centers (51, 14′) of said second (5) and third (14) gears spaced apart from each other by a second predetermined distance at least as great as said first predetermined distance (100′) and engaging said first gear (2);
a fourth gear (12A) rotatably mounted within said case (17) and engaging said second (5) and third (14) gears;
said fourth gear (12A) defining a second substantially C-shaped opening (102) substantially identical in size and shape with respect to said first C-shaped opening (100);
said fourth gear (12A) further defining first (30) and second (31) substantially identical C-shaped grooves therein, but with said second C-shaped opening (102) extending across and through said first C-shaped groove (30);
a housing (10) rotatably mounted with respect to said case (17) and defining a third substantially C-shaped opening (104) substantially identical in size and shape with respect to said first (100) and second (102) C-shaped openings;
a roller support (6) movably mounted within said housing (10) and defining a first protrusion (20) positioned in sliding relationship within said first C-shaped groove (30);
first (21) and second (22) rollers rotatably mounted on said roller support (6);
a blade support (12) movably mounted within said housing (10) and defining a second protrusion (18) positioned in sliding relationship within said second C-shaped groove (31);
a blade (28) rotatably mounted on said blade support (12);
first (9) and second (11) brake elements held in positions with respect to said case (17) and positioned for contacting said housing (10);
means (7, 8, 25, 26, 27 or 194, 196) in operative relationship with said first brake element (9) and with said case (17) for adjustably exerting force on said first brake element (9) and through said first brake element (9) on said housing (10);
means (32, 33) in operative relationship with said housing (10) and with said roller support (6) for selectively holding said roller support (6) in fixed position with respect to said housing (10) and for selectively enabling said roller support (6) to move with respect to said housing (10) under predetermined conditions;
said fourth gear (12A), said housing (10), said roller support (6) and said blade support (12) positioned in relationship with each other for rotation about a central axis (110) of said fourth gear (12A) as said first (2), second (5) and third (14) gears rotate said fourth gear (12A) in response to activation of said motor (16); and
said first (30) and second (31) grooves each defining first sections (30′, 31′), respectively, defined by a first radius (122) extending from said central axis (110) and second sections (30″, 31″), respectively.

25. A tube cutter (126) as in claim 24 wherein said second sections (30′, 31″) are each curved and are each at least partially defined by substantially one-quarter of a circumference of a circle (172) formed by a second radius (124) substantially one-half the length of said first radius (122).

26. A tube cutter (126) as in claim 25 wherein said second sections (30″, 31″) each further defines first and second intermediate locations (154, 156), respectively, and wherein said second sections (30″, 31″) each further defines end sections (158, 160), respectively, which are substantially straight and which extend along a portion of a line which subtends substantially one-quarter of circumferences of circles (174) formed by diameters extending between said central axis (110) and said first and second intermediate locations (154, 156), respectively.

27. A tube cutter (126) as in claim 24 wherein said second sections (30″, 31″) are each substantially straight and wherein each of said second sections (30″, 31″) subtends substantially one-quarter of a circumference of a circle (172) formed by a second radius (124) substantially one-half the length of said first radius (122).

28. A tube cutter (126) as in claim 27 wherein said second sections (30″, 31″) each further defines first and second intermediate locations (154, 156), respectively, and wherein said second sections (30″, 31″) each further defines end sections (158, 160), respectively, which are substantially straight and which extend along a portion of a line which subtends substantially one-quarter of circumferences of circles (174) formed by diameters extending between said central axis (110) and said first and second intermediate locations (154, 156), respectively.

29. A tube cutter (126) as in claim 27 wherein said second sections (30″, 31″) each further defines first and second intermediate locations (154, 156), respectively, and wherein said second sections (30″, 31″) each further defines end sections (158′, 160′), respectively, which are curved and which are each defined by substantially one-quarter of circumferences of circles (174) formed by diameters extending between said central axis (110) and said first and second intermediate locations (154, 156), respectively.

30. A tube cutter (126) as in claim 24 wherein said second C-shaped opening (102) extends across and through said first section (30′) of said first groove (30).

31. A tube cutter (126) as in claim 30 wherein said housing (10), said roller support (6) and said blade support (12) are configured and sized with respect to each other for enabling said roller support (6) and said blade support (12) to move only toward and away with respect to each other.

32. A tube cutter (126) as in claim 31 wherein said housing (10) defines first (106) and second (108) orthogonal axes passing through said extended central axis (110) of said fourth gear (12A) and wherein said blade (28) is substantially bisected by said first axis (106) and said rollers (21, 22) are spaced substantially equal distances from said first axis (106).

33. A tube cutter (126) as in claim 32 wherein said roller support (6) defines opposed, first (112) and second (114) elongated protrusions and wherein said blade support (12) defines opposed, first (116) and second (118) channels for, respectively, slidingly receiving said first (112) and second (114) elongated protrusions therein.

34. A tube cutter (126) as in claim 33 wherein said roller support (6) and said blade support (12) define opposed first (6′) and second (12′) arcuate surfaces, respectively, which substantially match said third C-shaped opening (104).

35. A tube cutter (126) as in claim 34 wherein said holding means (32, 33) include:
a first opening (128′) defined within said housing (10);
a second opening (130′) defined within said roller support (6) and located for selective alignment with said first opening (128′);
a compression spring (33′) positioned within said first opening (128′); and
a ball bearing (32′) positioned in contact with said spring (33′) and positioned simultaneously within said first (128′) and second (130′) openings for holding said roller support (6) in fixed position with respect to said housing (10) and for enabling said roller support (6) to move with respect to said housing (10) when said ball bearing (32′) exits said second opening (130′) as said roller support (6) and said blade support (12) move toward each other when said protrusions (18, 20) move into said second groove sections (31″, 30″), respectively.

36. A tube cutter (126) as in claim 35 wherein said force exerting means (7, 8, 25, 26, 27) include:
a pressure element (8) in contacting relationship with said first brake element (9);
a lever (7) movably attached to said pressure element (8) and defining a first opening (7′) therein;
a screw (25) adjustably connected to said lever (7) and extending through said case (17); and
a fulcrum shaft (27) connected to said case (17) and extending in movable relationship through said opening (7′).

37. A tube cutter (126) as in claim 36 wherein said housing (10) defines a first hub (10′) rotatably positioned with respect to said case (17) and wherein said fourth gear (12A) defines a second hub (12A′) rotatably positioned with respect to said case (17).

38. A tube cutter (126) as in claim 37 wherein said housing (10) defines a curved outer surface (10″), wherein said brake elements (9, 11) are each curved and contact said outer surface (10″) and wherein said pressure element (8) is curved and contacts said first brake element (9).

39. A tube cutter (126) as in claim 38 wherein said fourth gear (12A) is substantially disc-shaped defining an exterior edge (132) having gear teeth (134) therein and defining opposed sides (136, 138) and wherein said hub (12A′) and said grooves (30, 31) are located on said opposite sides (136, 138), respectively, of said disc-shaped fourth gear (12A).

40. A tube cutter (126) as in claim 39 wherein said roller support (6) defines first (142) and second (144) opposed and spaced-apart wall elements and a third (146) wall element extending between said first (142) and second (144) wall elements, and wherein said rollers (21, 22) are rotatably mounted with respect to and between said first (142) and second (144) wall elements.

41. A tube cutter (126) as in claim 40 further including first (23) and second (24) roller shafts extending between said first (142) and second (144) wall elements, and wherein said rollers (21, 22) are rotatably mounted on said roller shafts (23, 24), respectively.

42. A tube cutter (126) as in claim 41 wherein said first (142) and second (144) wall elements define said first arcuate surfaces (6′).

43. A tube cutter (126) as in claim 42 wherein said blade support (12) defines fourth (148) and fifth (150) opposed and spaced-apart wall elements and wherein said blade (28) is rotatably mounted with respect to and between said fourth (148) and fifth (150) wall elements.

44. A tube cutter (126) as in claim 43 further including a blade mounting shaft (29) extending between said fourth (148) and fifth (150) wall elements, and wherein said blade (28) is rotatably mounted on said blade shaft (29).

45. A tube cutter (126) as in claim 44 further including a base element (152) connected to said fourth (148) and fifth (150) wall elements and wherein said fourth (148) and fifth (150) wall elements and said base element (152) define said second (12′) arcuate surfaces.

46. A tube cutter (126) as in claim 45 wherein said base element (152) is sized and configured to slidably fit between said first (142) and second (144) wall elements as said roller support (6) and said blade support (12) move toward and away from each other.

47. A tube cutter (126) as in claim 1 wherein said second C-shaped opening (102) defines first and second opposed, spaced-apart walls (102′, 102″), wherein said fourth gear (12A) defines an exterior edge (132) having gear teeth (134) therein, wherein said second section (31″) is located between said first wall (102′) and said edge (132), and wherein said first section (30″) is located between an imaginary straight line extension (103) of said second wall (102″) and said edge (132).

48. A tube cutter (126) as in claim 24 wherein said second C-shaped opening (102) defines first and second opposed, spaced-apart walls (102′, 102″), wherein said fourth gear (12A) defines an exterior edge (132) having gear teeth (134) therein, wherein said second section (31″) is located between said first wall (102′) and said edge (132), and wherein said first section (30″) is located between an imaginary straight line extension (103) of said second wall (102″) and said edge (132).

49. A tube cutter (126) as in claim 15 further including brake elements retaining members (37, 37′) connected to said case (17) adjacent to said opening (100) for limiting movement of said brake elements (9, 11), respectively, as said housing (10) rotates about said central axis (110).

50. A tube cutter (126) as in claim 49 wherein said housing (10) defines an exterior circumference (162), wherein said brake elements (9, 11) each defines an interior curved surface (9′, 11′), respectively, contacting said exterior circumference (162) and wherein the combined lengths of said curved surfaces (9′, 11′) are less than said exterior circumference (162).

51. A tube cutter (126) as in claim 38 further including brake elements retaining members (37, 37′) connected to said case (17) adjacent to said opening (100) for limiting movement of said brake elements (9, 11), respectively, as said housing (10) rotates about said central axis (110).

52. A tube cutter (126) as in claim 51 wherein said housing (10) defines an exterior circumference (162), wherein said brake elements (9, 11) each defines an interior curved surface (9′, 11′), respectively, contacting said exterior circumference (162) and wherein the combined lengths of said curved surfaces (9′, 11′) are less than said exterior circumference (162).

53. A portable, hand-held, motor-driven, tube cutter (126), comprising:
an exterior case (17) having a handle (17′) and defining a first substantially C-shaped opening (100) therein having a width (100′) of a first predetermined distance;
an electric motor (16) mounted within said case (17);
means (1) in operative relationship with said motor (16) and mounted on said case (17) for selectively activating said motor (16) in forward and reverse directions;
a first gear (2) connected to said motor (16);
a bearing (3) mounted within said case (17) and rotatably supporting said first gear (2);
second (5) and third (14) gears of substantially identical dimensions, rotatably mounted within said case (17), centers (5′, 14′) of said second (5) and third (14) gears, respectively, spaced apart from each other by a second pre-determined distance at least as great as said first predetermined distance (100′) and engaging said first gear (2);
a fourth gear (12A) rotatably mounted within said case (17) and engaging said second (5) and third (14) gears;
said fourth gear (12A) defining a second substantially C-shaped opening (102) substantially identical in size and shape with respect to said first C-shaped opening (100);
said fourth gear (12A) further defining first (30) and second (31) substantially identical C-shaped grooves therein, but with said second C-shaped opening (102) extending across and through said second C-shaped groove (31);
a housing (10) rotatably mounted with respect to said case (17) and defining a third substantially C-shaped opening (104) substantially identical in size and shape with respect to said first (100) and second (102) C-shaped openings;
a roller support (6) movably mounted within said housing (10) and defining a first protrusion (20) positioned in sliding relationship within said first C-shaped groove (30);
first (21) and second (22) rollers rotatably mounted on said roller support (6);
a blade support (12) movably mounted within said housing (10) and defining a second protrusion (18) positioned in sliding relationship within said second C-shaped groove (31);
a blade (28) rotatably mounted on said blade support (12);
means (182, 184, 186, 188, 190, 192) in operative relationship with said housing (10) and with said case (17) for retarding rotation of said housing (10) with respect to said case (17);
means (32, 33) in operative relationship with said housing (10) and with said blade support (12) for selectively holding said blade support (12) in fixed position with respect to said housing (10) and for selectively enabling said blade support (12) to move with respect to said housing (10) under predetermined conditions;
said fourth gear (12A), said housing (10), said roller support (6) and said blade support (12) positioned in relationship with each other for rotation about a central axis (110) of said fourth gear (12A) as said first (2), second (5) and third (14) gears rotate said fourth gear (12A) in response to activation of said motor (16); and
said first (30) and second (31) grooves each defining first sections (30′, 31′), respectively, defined by a first radius (122) extending from said central axis (110) and second sections (30″, 31″), respectively.

54. A portable, hand-held, motor-driven, tube cutter (126), comprising:
an exterior case (17) having a handle (17′) and defining a first substantially C-shaped opening (100) therein;
an electric motor (16) mounted within said case (17);
means (1) in operative relationship with said motor (16) and mounted on said case (17) for selectively activating said motor (16) in forward and reverse directions;
a first gear (2) connected to said motor (16);
a bearing (3) mounted within said case (17) rotatably supporting said first gear (2);
second (5) and third (14) gears of substantially identical dimensions, rotatably mounted within said case (17), and centers (5′, 14′) of said second (5) and third (14) gears spaced apart from each other by a second predetermined distance at least as great as said first predetermined distance (100′) and engaging said first gear (2);
a fourth gear (12A) rotatably mounted within said case (17) and engaging said second (5) and third (14) gears;
said fourth gear (12A) defining a second substantially C-shaped opening (102) substantially identical in size and shape with respect to said first C-shaped opening (100);
said fourth gear (12A) further defining first (30) and second (31) substantially identical C-shaped grooves therein, but with said second C-shaped opening (102) extending across and through said first C-shaped groove (30);
a housing (10) rotatably mounted with respect to said case (17) and defining a third substantially C-shaped opening (104) substantially identical in size and shape with respect to said first (100) and second (102) C-shaped openings;
a roller support (6) movably mounted within said housing (10) and defining a first protrusion (20) positioned in sliding relationship within said first C-shaped groove (30);
first (21) and second (22) rollers rotatably mounted on said roller support (6);
a blade support (12) movably mounted within said housing (10) and defining a second protrusion (18) positioned in sliding relationship within said second C-shaped groove (31);
a blade (28) rotatably mounted on said blade support (12);
means (182, 184, 186, 188, 190, 192) in operative relationship with said housing (10) and with said case (17) for retarding rotation of said housing (10) with respect to said case (17);
means (32, 33) in operative relationship with said housing (10) and with said roller support (6) for selectively holding said roller support (6) in fixed position with respect to said housing (10) and for selectively enabling said roller support (6) to move with respect to said housing (10) under predetermined conditions;
said fourth gear (12A), said housing (10), said roller support (6) and said blade support (12) positioned in relationship with each other for rotation about a central axis (110) of said fourth gear (12A) as said first (2), second (5) and third (14) gears rotate said fourth gear (12A) in response to activation of said motor (16); and
said first (30) and second (31) grooves each defining first sections (30′, 31′), respectively, defined by a first radius (122) extending from said central axis (110) and second sections (300″, 31″), respectively.
